(19) United States
(12) Patent Application Publication
(10) Pub. No.: US 2019/0287085 A1
(43) Pub. Date: Sep. 19, 2019

(54) SYSTEMS AND METHODS FOR MANAGING CONSUMPTION OF MEDIA ITEMS

(71) Applicant: GOPRO, INC., San Mateo, CA (US)

(72) Inventor: Simon Seidler, San Jose, CA (US)

(21) Appl. No.: 15/344,387

(22) Filed: Nov. 4, 2016

(51) Int. Cl. G06Q 20/12; G06Q 20/40

(52) U.S. Cl. CPC G06Q 20/123; G06Q 20/405

(57) ABSTRACT

A database may include media account information for media accounts corresponding to media items, consumer account information for consumer accounts corresponding to consumers, and charge information for the media accounts. Media account information may include media account values for the media accounts. Consumer account information may include consumer account values for the consumer accounts. Charge information may define charge rules for consumption of the media items. An occurrence of a consumption event for a media item may be determined. Responsive to determination of the occurrence of the consumption event, consumption information may be generated. The consumption information may identify (1) consumer account of the consumer that consumed the media item, (2) date and/or time of the consumption, and (3) a type of the consumption. A consumer account value and a media account value may be changed based on the consumption information and/or the charge information.

### FIELD

This disclosure relates to systems and methods that manage consumption of media items.

### BACKGROUND

Consumers may consume (e.g., play, view, change, listen to) a media item by itself or with another media item. For example, a consumer may listen to a song by itself or may listen to the song synchronized to a video. Based on the type of consumption, different rights of the media item may be triggered.

### SUMMARY

This disclosure relates to managing consumption of media items. A database may include media account information for media accounts corresponding to media items, consumer account information for consumer accounts corresponding to consumers, and charge information for the media accounts. Media account information may include media account values for the media accounts. Consumer account information may include consumer account values for the consumer accounts. Charge information may define charge rules for consumption of the media items. An occurrence of a consumption event for a media item may be determined. Responsive to determination of the occurrence of the consumption event, consumption information may be generated. The consumption information may identify (1) consumer account of the consumer that consumed the media item, (2) date and/or time of the consumption, and (3) a type of the consumption. A consumer account value and a media account value may be changed based on the consumption information and/or the charge information.

A system that manages consumption of media items may include one or more of physical storage media, processors, and/or other components. The physical storage media may store one or more databases and/or other information. A database may include media account information for media accounts corresponding to individual media items, consumer account information for consumer accounts corresponding to individual consumers, charge information for individual media accounts, and/or other information.

The media account information for individual media accounts may include a media account value and/or other information. The media accounts may include a first media account corresponding to a first media item and/or other media accounts. The media account information for the first media account may including a first media account value and/or other information.

The consumer account information for individual consumer accounts may include a consumer account value and/or other information. The consumer accounts may include a first consumer account corresponding to a first consumer and/or other consumer accounts. The consumer account information for the first consumer account may include a first consumer account value and/or other information.

The charge information may define one or more charge rules for consumption of individual media items. The charge information may define independent charge rules for independent consumption of individual media items, derivative charge rules for derivative consumption of individual media items, and/or other charge rules. The charge information may include first charge information for the first media account. The first charge information may define a first independent charge rule, a first derivative charge rule, and/or other charge rules for the first media item.

In some implementations, the database may include distribution account information for a set of distribution accounts associated with the first media account and distribution information associated with the first media account. The set of distribution accounts may include one or more distribution accounts. In some implementations, the set of distribution accounts may include one or more rights-holder accounts. In some implementations, the set of distribution accounts may include second and/or other media accounts corresponding to second and/or other media items.

The distribution account information for individual distribution accounts may include a distribution account value and/or other information. The distribution information may define one or more distribution rules for distributing at least a portion of the increase in the first media account value among the set of distribution accounts.

The processor(s) may be configured by machine-readable instructions. Executing the machine-readable instructions may cause the processor(s) to facilitate managing consumption of media items. The machine-readable instructions may include one or more computer program components. The computer program components may include one or more of a consumption event component, a consumption information component, account value component, and/or other computer program components. In some implementations, the computer program components may include a charge information component, media information component, distribution component, and/or other computer program components.

The consumption event component may be configured to determine an occurrence of a consumption event for one or more of the media item. The consumption event component may determine an occurrence of a consumption event for the first media item based on the consumption of the first media item by the first consumer.

The consumption information component may be configured to, responsive to determination of the occurrence of the consumption event for the first media item, generate consumption information for the first media item. The consumption information may identify (i) the first consumer account based on the first consumer's consumption of the first media item, (ii) a date and/or a time of the first consumer's consumption of the first media item, (iii) a type of the first consumer's consumption of the first media item, and/or other information. In some implementation, the consumption information may identify one or more consumer devices used for the first consumer's consumption of the first media item.

The account value component may be configured to change the first consumer account value, the first media account value, and/or other information. In some implementations, changing the first consumer account value may include decreasing the first consumer account value by a charge value.

The first media account value may be changed based on the first charge information and the consumption information. The first media account value may be changed using the first independent charge rule based on the consumption information indicating an independent consumption of the first media item and/or other information. The first media account value may be changed using the first derivative charge rule based on the consumption information indicating a derivative consumption of the first media item and/or other information. In some implementations, changing the first media account value may include increasing the first media account value by at least a portion of the charge value.

The charge information component may be configured to set and/or change the charge information. The charge information component may set and/or change one or more rules for consumption of individual media items. The charge information component may set and/or change one or more of the first independent charge rule, the first derivative charge rule, and/or other charge rules for the first media item.

The media information component may be configured to store first media information defining the first media item in one or more storage media. The media information component may be configured to provide the first media information defining the first media item to a consumer device.

The distribution component may be configured to distribute at least a portion of the increase in the first media account value among the set of distribution accounts using the distribution rule and/or other information. The distribution component may distribute at least the portion of the increase in the first media account value among one or more rights-holder accounts, one or more other media accounts, and/or other accounts.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system that manages consumption of media items.

FIG. 2 illustrates a method for managing consumption of media items.

FIG. 3 illustrates exemplary consumer accounts and consumer account values.

FIG. 4 illustrates exemplary media account, media account value, and media charge information.

FIG. 5 illustrates exemplary media account, media account value, media charge information, set of distribution accounts, and distribution information.

FIG. 6 illustrates exemplary interface showing rights information for a media item.

FIG. 7 illustrates an exemplary system that includes consumer devices, a server, and a network for managing consumption of media items.

### DETAILED DESCRIPTION

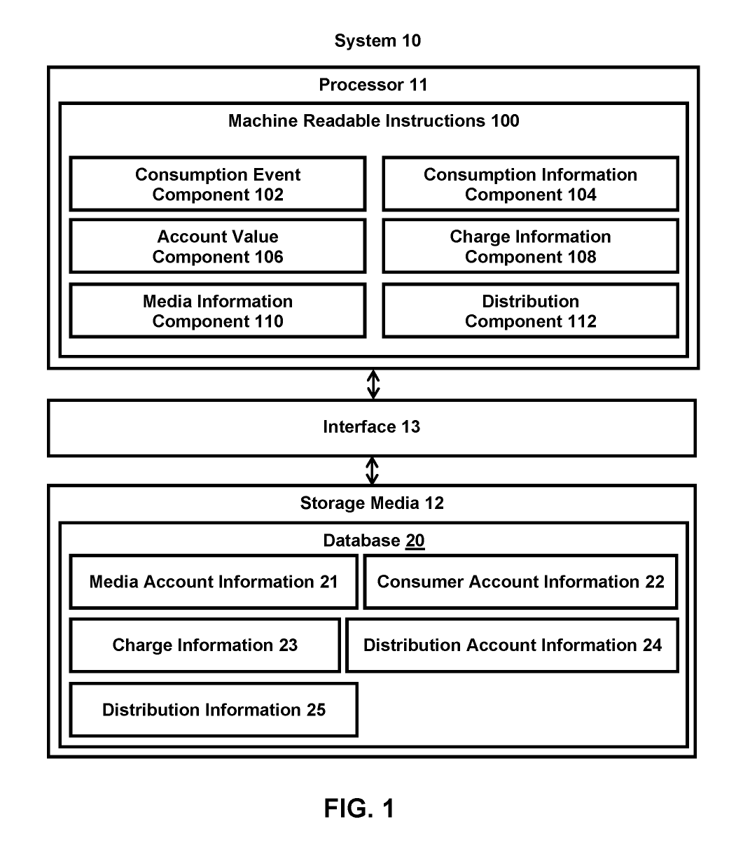

FIG. 1 illustrates system 10 for managing consumption of media items. System 10 may include one or more of processor 11, storage media 12, interface 13 (e.g., bus, wireless interface), and/or other components. Storage media 12 may store database 20. Database 20 may include media account information 21 for media accounts corresponding to media items, consumer account information 22 for consumer accounts corresponding to consumers, and charge information 23 for the media accounts. Media account information 21 may include media account values for the media accounts. Consumer account information 22 may include consumer account values for the consumer accounts. Charge information 23 may define charge rules for consumption of the media items. Processor 11 may determine an occurrence of a consumption event for a media item. Responsive to determination of the occurrence of the consumption event, processor 11 may generate consumption information. The consumption information may identify (1) consumer account of the consumer that consumed the media item, (2) date and/or time of the consumption, and (3) a type of the consumption. A consumer account value and a media account value may be changed based on the consumption information and/or charge information 23.

Storage media 12 may include electronic storage media that electronically stores information. Storage media 12 may store software algorithms, information determined by processor 11, information received remotely, and/or other information that enables system 10 to function properly. For example, storage media 12 may store information relating to databases, media items, media accounts, consumers, consumer accounts, charge rules, distribution rules, and/or other information. System 10 may include electronic storage separate from storage media 12. Electronic storage separate from storage media may perform one or more of the functionalities of storage media 12 discussed above.

Storage media 12 may store one or more databases and/or other information. For example, storage media 12 may store database 20 and/or other information. Database 20 may include media account information 21 for media accounts corresponding to individual media items, consumer account information 22 for consumer accounts corresponding to individual consumers, charge information 23 for individual media accounts, and/or other information. In some implementations, database 20 may include distribution account information 24 for a set of distribution accounts associated with one or more media accounts and distribution information 25 associated with one or more media accounts.

A consumer may refer to a person and/or an entity that may consume (e.g., play, view, change, listen to) media items. A consumer account may refer to an account/record in database 20 that corresponds to a particular consumer. One or more consumer accounts for one or more consumers may be setup in database 20 by one or more consumers (e.g., via consumer registration) or through linking with other consumer accounts (e.g., linking with a consumer account setup in another database).

A consumer account may include/store consumer account values and/or other information. The consumer account value may refer to a value stored in database 20. The consumer account value may change based on a consumer's consumption of one or more media items. The consumer account value may refer to a value that may be used/spent as consideration for consumption of media items and/or other transactions relating to media items. For example, the consumer account value may refer to virtual currency and/or other numbers (e.g., points) that may be “spent” by a consumer to play, view, change, listen to, and/or otherwise consume media items. The virtual currency and/or other numbers may be increased (e.g., credited, incremented) or decreased (e.g., debited, decremented) based on consumption of media items.

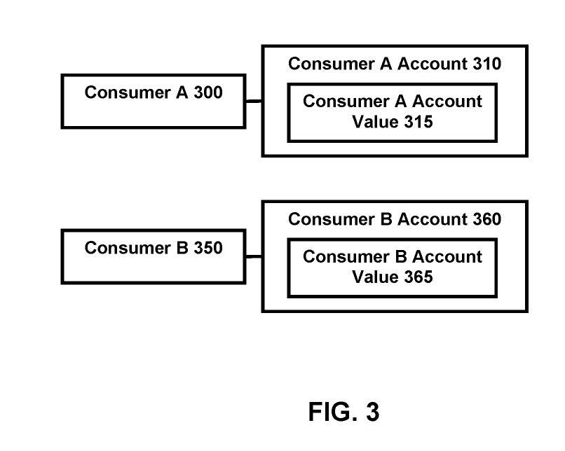

Consumer account information 22 for individual consumer accounts may include a consumer account value and/or other information. For example, referring to FIG. 3, consumers may include consumer A 300, consumer B 350, and/or other consumers. Consumer A account 310 and/or other consumer accounts may correspond to consumer A 300. Consumer account information 22 for consumer A 300 may include consumer A account value 315 and/or other information. Consumer B account 360 and/or other consumer accounts may correspond to consumer B 350. Consumer account information 22 for consumer B 350 may include consumer B account value 365 and/or other information.

Media items may refer to audio and/or visual content that may be consumed by consumers. Media items may be static or dynamic. Media items may include one or more of an image, a video, a sound, a song, a movie, and/or other media items. A media account may refer to an account/record in database 20 that corresponds to a particular media item. One or more media accounts for one or more media items may be setup in database 20 by one or more creators/users of media items (e.g., during media item upload to a server) or through linking with other media accounts (e.g., linking with a media account setup in another database).

A media account may include/store media account values and/or other information. The media account value may refer to a value stored in database 20. The media account value may change based on consumption of the media item by one or more consumers. The media account value may refer to a value that reflects consumption of media items by one or more consumers and/or other transactions relating to media items. For example, the media account value may refer to virtual currency and/or other numbers (e.g., points) that may be increased based on a consumer's playing, viewing, changing, listening, and/or other consumption activities of the media item.

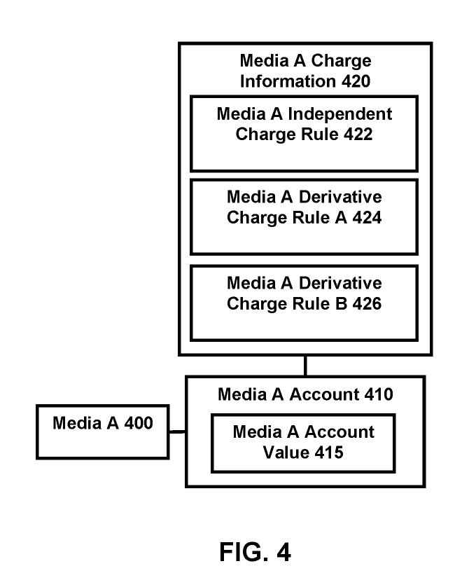

Media account information 21 for individual media accounts may include a media account value and/or other information. For example, referring to FIG. 4, media items may include media A 400 (e.g., an image, a video, a sound, a song, a movie) and/or other media items. Media A Account 410 and/or other media accounts may correspond to media A 400. Media account information 21 for media A 400 may include media A account value 415 and/or other information.

Charge information 23 may define one or more charge rules for consumption of individual media items. For example, charge information 23 may define one or more independent charge rules for independent consumption of individual media items, one or more derivative charge rules for derivative consumption of individual media items, and/or other charge rules. The type of consumption of media items may determine which charge rules (e.g., type of license for media items) are applicable.

An independent charge rule may refer to one or more instructions and/or arrangements by which consumer accounts value(s) and/or media account value(s) may be changed in response to an independent consumption of a media item. An independent consumption of a media item may refer a consumption of the media by itself. An independent consumption of a media item may include a consumption of the media without changes to the media. For example, an independent consumption of a song may include a user listening to the song by itself, without any changes to the song.

A derivative charge rule may refer to one or more instructions and/or arrangements by which consumer accounts value(s) and/or media account value(s) may be changed in response to a derivative consumption of a media item. A derivative consumption of a media item may refer to a consumption of the media item with another media item. A derivative consumption of a media item may include a consumption of the media with changes to the media. For example, a derivative consumption of a song may include a user listening to the song synchronized to a video and/or a remix of the song. A media item may be associated with one or multiple derivative charge rules. For example, a song may be associated with multiple derivative charge rules that define particular changes in consumer accounts value(s) and/or media account value(s) based on (1) whether the song is consumed with other song(s), sound(s), image(s), video(s), and/or movie(s), (2) how much of the song is consumed, (3) how much of the song is changed, and/or other derivative consumption of the song.

In some implementations, charge rules may define one or more prohibited consumption of media items. For example, an independent charge rule may prohibit an independent consumption of a media item, an independent consumption of the media item at particular times/geographical areas, an independent consumption of the media item by particular consumers, and/or other independent consumption of the media item. A derivative charge rule may prohibit a derivative consumption of a media item, a particular type of derivative consumption of the media item, a derivative consumption of the media item with another particular media item, a derivative consumption of the media item at particular times/geographical areas, a derivative consumption of the media item by particular consumers, and/or other derivative consumption of the media item.

Charge information 23 may include different charge information for different media items/media accounts. For example, referring to FIG. 4, charge information 23 may include media A charge information 420 for media A account 410. Media A charge information 420 may define media A independent charge rule 422, media A derivative charge rule A 424, media A derivative charge rule B 426, and/or other charge rules for consumption of media A 400.

In some implementations, a media account may be associated with a set of distribution accounts. A set of distribution accounts may include one or more distribution accounts. A distribution account may refer to an account/record in database 20 that shares values (e.g., virtual currency, points) stored in a media account and/or receives values from a media account. A distribution account may correspond to a person, an entity, and/or a media item.

A distribution account may include/store distribution account values and/or other information. The distribution account value may refer to a value stored in database 20. The distribution account value may change based on consumption of the media item to which the distribution account is associated. In some implementations, a set of distribution accounts for a media item may include one or more rights-holder accounts. Rights-holder accounts may include accounts corresponding to persons/entities that hold rights in the media item. For example, a media item may include a song and the set of distribution accounts for the song may include one or more rights-holder accounts corresponding to the writer(s) of the song, the performer(s) of the song, the producer(s) of the song, and/or other persons/entities holding rights to the consumption of the song.

In some implementations, a set of distribution accounts for a media item may include media accounts corresponding to other media items. For example, a media item may include may include a remix of two songs, and the set of distribution accounts for the song may include media accounts corresponding to the two songs used in the remixed song.

In some implementations, a set of distribution accounts for a media item may include one or more rights-holder accounts and one or more media accounts. For example, a media item may include a synchronization of a video and a music, and the set of distribution accounts may include a rights-holder account corresponding to the person that synchronized the video and the music, a media account corresponding to the video, and a media account corresponding to the music. Other combinations of distribution accounts are contemplated.

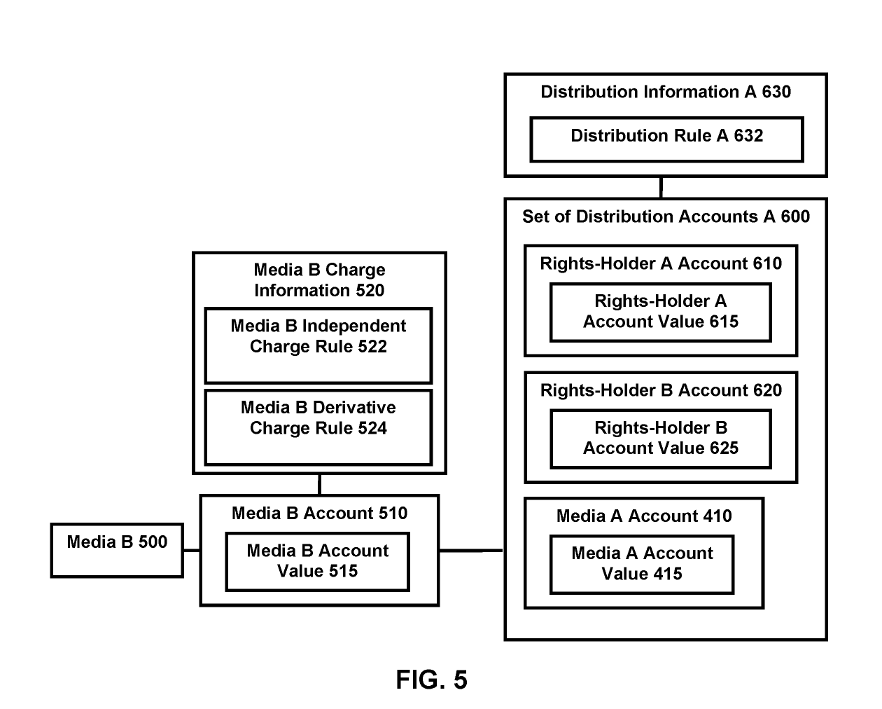

Database 20 may include distribution account information 24 for one or more sets of distribution accounts associated with media account(s) and distribution information 25 associated with the media account(s). For example, referring to FIG. 5, database 20 may include distribution account information 24 for set of distribution accounts A 600 associated with media B account 510. Media B 500 may include two rights-holders and a derivative use (e.g., remix, sampling, synchronization) of media A 400. The two rights-holders of media B 500 may include two persons/entities that modified media A 400 to create media B 500 and/or otherwise hold rights in media B 500. Referring to FIG. 5, set of distribution accounts A 600 may include rights-holder A account 610, rights-holder B account 620, media A account 410, and/or other distribution accounts.

Distribution account information 24 for individual distribution accounts may include a distribution account value and/or other information. For example, distribution account information 24 for rights-holder A account 610 may include rights-holder A account value 615 and distribution account information 24 for rights-holder B account 620 may include rights-holder B account value 625. In some implementations, one or more rights-holders may include one or more consumers, and rights-holder account value (e.g., 615, 625) may be included in consumer account information 22. Media A account value 415 for media A account 410 may be included in distribution account information 24 and/or media account information 21.

Distribution information 24 may define one or more distribution rules for distributing at least a portion of a media account value among a set of distribution accounts. A distribution rule may refer to one or more instructions and/or arrangements by which at least a portion of a media account value is distributed/split among a set of distribution accounts. The value to be distribution/split among a set of distribution accounts may be distributed evenly among the set of distribution accounts or unevenly among the set of distribution accounts.

One or more distribution rules may be determined based on charge rules for one or more media items. For example, media B 500 may be created by changing media A 400. Distribution rule A 632 may be determined using media A derivative charge rule A 424, media A derivative charge rule B 426, and/or other derivative charge rule for media A 400 based on how media A 400 was used to create media B 500. For example, media A derivative charge rule A 424 may require 50% of earnings from consumption of media items that remixes media A 400 to be paid to media A account 410. Media A derivative charge rule B 426 may require a certain amount to be paid to media A account 410 for consumption of media items that samples media A 400. Other determinations of distribution rules are contemplated.

Arrangement of distribution accounts may provide for a hierarchical distribution of values from a media account into other accounts. For example, media B account value 515 may be increased by a certain amount based on a consumer's consumption of media B 500. Distribution information 24 may include distribution information A 630. Distribution information A 630 may define one or more distribution rules (e.g., distribution rule A 632) for distributing a part or the entirety of the increased amount in media B account value 515 among set of distribution accounts A 600 (e.g., rights-holder A account 610, rights-holder B account 620, media A account 410). In some implementations, media A account 410 may have a set of distribution accounts. A part or the entirety of the increase in media A account value 415 (e.g., received from media B account value 515) may further be distributed to distribution accounts associated with media A account 410.

In some implementations, application of one or more distribution rules may depend on the type of media consumption by one or more consumers. For example, a distribution rule A 632 may define different distributions of values from media B account 510 based on whether media B 500 is independently or derivatively consumed, and/or on the particular type of derivative consumption. For example, media B 500 may include a movie having a video part and an audio part. Distribution rule A 632 may define different distributions of values from media B account 510 among set of distribution account A 600 based on whether the derivative consumption of media B 500 used the video part of the movie, the audio part of the movie, and/or both the video and audio parts of the movie.

Processor 11 may be configured to provide information processing capabilities in system 10. As such, processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. Processor 11 may be configured to execute one or more machine readable instructions 100 to facilitate managing consumption of media items. Machine readable instructions 100 may include one or more computer program components. Machine readable instructions 100 may include one or more of consumption event component 102, consumption information component 104, account value component 106, and/or other computer program components. In some implementations, the computer program components may include charge information component 108, media information component 110, distribution component 112, and/or other computer program components.

Consumption event component 102 may be configured to determine an occurrence of a consumption event for one or more media item. A consumption event for a media item may indicate a consumption of the media item by a particular consumer. For example, consumption event component 102 may determine an occurrence of a consumption event for media A 400 based on the consumption of media A 400 by consumer A 300. Consumption event component 102 may determine an occurrence of a consumption event based on a consumer's playing, viewing, changing, listening, and/or other consumption activities of the media item. Consumption event component 102 may determine an occurrence of a consumption event at the beginning of a user's consumption, during the user's consumption, or at/after the end of the user's consumption. In some implementations, consumption event component 102 may determine time duration between multiple consumptions of a media item by a consumer.

Consumption information component 104 may be configured to, responsive to determination of the occurrence of the consumption event for a media item, generate consumption information for the media item. The consumption information may be stored in storage media 12 and/or other electronic storage. The consumption information may identify (i) a particular consumer account based on a particular consumer's consumption of the media item, (ii) a date and/or a time of the consumer's consumption of the media item, (iii) a type of the consumer's consumption of the media item, and/or other information. For example, responsive to determination of the occurrence of a consumption event for media A 400 based on the consumption of media A 400 by consumer A 300, consumer information component 104 may generate consumption information identifying (i) consumer A account 310, (ii) a date and/or a time of consumption of media A 400 by consumer A 300, (iii) whether consumer A 300 consumed media A 400 independently or derivatively, and/or other information relating to consumption of media A 400 by consumer A 300.

In some implementations, consumption information may identify information relating to derivative consumption of media items. For example, in response to a consumer's derivative consumption of media A 400 and media B 500 (e.g., media A 400 and media B 500 include songs and a consumer listens to a remix of media A 400 and media B 500), consumption information component 104 may generate consumption information that identifies how much of media A 400 and media B 500 was consumed in the derivative consumption, how media A 400 and media B 500 was used in the derivative consumption, and/or other information relating to the derivative consumption of media A 400 and media B 400.

In some implementation, the consumption information may identify one or more consumer devices used for the consumer's consumption of the media item. A consumer device may refer to a computing device (e.g., computer, handheld device, phone, camera) through which the consumer may play, view, change, listen to, and/or otherwise consume a media item. The consumption information may identify a particular consumer device used by consumer A 300 to consume media A 400.

Account value component 106 may be configured to change one or more consumer account values, one or more media account values, and/or other information. Account value component 106 may change a consumer account value based on a consumer's consumption of a media item. For example, account value component 106 may change consumer A account value 315 based on consumption of media A 400 by consumer A 300. In some implementations, changing a consumer account value may include decreasing the consumer account value by a charge value. In some implementations, changing a consumer account value may include increasing the consumer account value by a charge value.

A charge value may refer to an amount deducted from (or added to) the consumer account for a consumption of a media item. The charge value may be static or dynamic. For example, consumer A account value 315 may be decreased by the same charge value (e.g., virtual currency, points) every time consumer A 300 consumes a media item (e.g., media A 400, media B 500). Consumer A account value 315 may be decreased by different charge values based on the particular media item consumed (e.g., different charge values for consumption of media A 400 versus media B 500), based on the type of consumption (e.g., independent consumption vs derivative consumption), the type of consumer device used to consume the media item, and/or other information.

In some implementations, account value component 106 may not change a consumer account value if it determines that a user has consumed a media item multiple times within a certain time duration. For example, a user may be charged a charge value for the first consumption of media B 500 and may be allowed to consumed media B 500 again within a 24-hour period without incurring additional charges.

In some implementations, account value component 106 may change a consumer account value differently based on whether a consumer independently consumes a media item, derivatively consumes a media item, or both independently and derivatively consumes a media item. For example, account value component 106 may change a consumer account value by a certain charge value (e.g., 3) in response to an independent consumption of media B 500. Account value component 106 may change a consumer account value by a different charge value (e.g., 2) in response to a derivative consumption of media B 500. Responsive to a consumer's independent and derivative consumption of media B 500, account value component 106 may change a consumer account value such that the total charged for the consumer's independent and derivative consumption of media B 500 is less than the combination of the charge for the independent consumption and the charge for the derivative consumption. For example, account value component 106 may change a consumer account value by 3 in response to the independent consumption of media B 500. In response to the consumer later derivatively consuming media B 500, account value component 1067 may change the consumer account value by an amount less than 2.

Account value component 106 may change one or more media account values based on charge information 23 and the consumption information. For example, media A account value 415 may be changed using media A independent charge rule 422 based on the consumption information indicating an independent consumption of media A 400 and/or other information. Media account value 415 may be changed using media A derivative charge rule A 424 or media A derivative charge rule B 426 based on the consumption information indicating a particular derivative consumption of the media A 400 and/or other information. In some implementations, changing one or more media account values may include increasing the media account values by at least a portion of the charge value. In some implementations, changing one or more media account values may include decreasing the media account values by at least a portion of the charge value. For example, based on consumption of media A 400 by consumer A 300, consumer A account value 315 may be decreased by a charge value. Account value component 106 may increase media A account value 415 by the charge value or a portion of the charge value.

Increasing media A account value 415 by the charge value may effectuating a swap of the charge value from consumer A account value 315 to media A account value 415. Increasing media A account value 415 by a portion of the charge value may effectuate an extraction of a service charge from the charge value. For example, a percentage of the charge value may be stored in a service charge account and the remainder may be added to media A account value 415. A service charge may refer to a charge on consumption of media items by a service provider (e.g., media item hosting service). In some implementations, a service charge may be taken out from a media account. In some implementations, a service charge account may be included as a distribution account of a media account.

Charge information component 108 may be configured to set and/or change charge information 23. Charge information component 108 may set and/or change one or more rules for consumption of individual media items. For example, charge information component 108 may set and/or change one or more of media A charge information 420, media B charge information 520, and/or other charge information. Charge information component 108 may set and/or change one or more of media A independent charge rule 422, media A derivative charge rule A 424, media A derivative charge rule B 426, media B independent charge rule 522, media B derivative charge rule 524, and/or other charge rules. Charge information component 108 may add a new independent charge rule, add a new derivative charge rule, remove an independent charge rule, or remove a derivative charge rule from charge information 23.

Charge information component 108 may restrict persons/entities who may set and/or change charge information 23 for different media items. For example, charge information component 108 may only allow one or more rights-holders of a media item to set and/or change charge information 23 for the media item. Charge information 108 may restricts times during which charge information 23 may be set and/or changed. For example, charge information component 108 may allow charge information 23 for a media item to be set when the media item is created/uploaded to a media item hosting service, and may allow charge information 23 for the media item to be changed after charge information 23 has been initially set. Charge information component 108 may allow charge information 23 for a media item to be changed during a certain time of day/week/month/year. In some implementations, charge information component 108 may monitor changes in charge information 23 and notify consumers and/or rights holders of changes in charge information 23.

Distribution component 112 may be configured to distribute at least a portion of the increase/decrease in a media account value among the set of distribution accounts using the distribution rule and/or other information. Distribution component 112 may distribute at least the portion of the increase/decrease in the media account value among one or more rights-holder accounts, one or more other media accounts, and/or other accounts. For example, distribution component 112 may distribute at least a portion of a charge value added to media B account value 515 (responsive to consumption of media B 500) to one or more distribution accounts in set of distribution accounts A 600. The entirety or a portion of the charge value may be distributed among rights-holder A account 610, rights-holder B account 620, media A account 410, and/or other accounts based on distribution rule A 632.

In some implementations, the distribution of a charge value among a set of distribution accounts may be effectuated from initial transfer of values from a consumer account. For example, rather than a charge value being deducted from consumer A account value 315, added to media B account value 515, and then subsequently being distributed to rights-holder A account value 615, rights-holder B account value 625, and media A account value 415, the charge value may be split up among media B account value 515, rights-holder A account value 615, rights-holder B account value 625, and media A account value 415.

Media information component 110 may be configured to store media information defining one or more media items in one or more storage media. Media information component 110 may store media information during creation of a media item or after the creation of the media item. For example, media information component 110 may store media information for a remixed song as a person remixes the song. Media information component 110 may store media information for the remixed song after receiving an indication that the remix of the song has been completed. Media information component 110 may store media information for a media item after media information component 110 receives media information from a remote location (e.g., a creator of a media item uploads the media information).

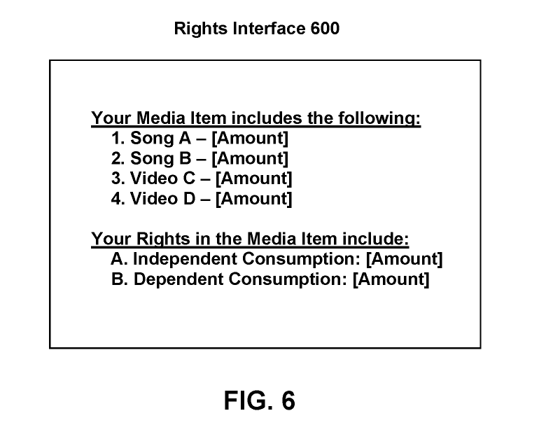

In some implementations, media information component 110 may be configured to provide rights information for a media item. Rights information for a media item may include information relating to rights-holders of the media item and/or composition of the media item. For example, FIG. 6 illustrates exemplary rights interface 600 showing rights information for a derivative media item. Rights information for a media item may include how much a creator of the media item may receive for an independent consumption of the media item and a derivative consumption of the media item. The rights information for a media item may include how much distribution accounts may receive for a consumption of the media item.

For example, rights interface 600 may provide information relating to what other media items (e.g., Song A, Song B, Video C, Video D) are included in the derivative media item and the amount of the other media items included in the derivative media item. The amount of the other media items may reflect what part of other media items are included in the derivative media item. For example, 50% of song A, 75% of song B, 100% of video C, and 20% of video D may be included in the derivative media item. The amount of the other media items may reflect what parts of the derivative media item are created from the other media items. For example, 25% of the derivative media item may include song A, 50% of the derivative media item may include song B (25% of the derivative media item may not include song A or song B), 90% of the derivative media item may include video C, and 15% of the derivative media item may include video D (5% of the derivative media item may include both video C and video D).

Providing rights information for a media item may allow a media item creator to see the results of media item creation. Providing rights information for a media item may allow a media item creator to change the composition of the media item to arrive at a particular composition and/or a particular distribution of rights (e.g., particular earnings for independent and/or derivative consumption of the media item).

In some implementations, rights interface 600 may provide information relating to conflicting rights in derivative uses of media items. For example, a media item creator may attempt to use a video and a song to create a music video. The derivative charge rules for the video and the songs may not allow the media item creator to create the music video as originally planned by the media item creator. For example, based on the amount of the video used in the music video, a derivative charge rule for the video may require 60% of earnings from consumption of music video to be paid to the media account for the video. Based on the amount of the song used in the music video, a derivative charge rule for the song may require 90% of earnings from consumption of music video to be paid to the media account for the song. Rights interface 600 may provide information about the conflicts in distribution rights for the derivative uses of the video and the song in the music video. Such provision of conflicting rights information may enable the media item creator to change the composition of the music video so that the music video does not conflict with derivative charge rules of the video and/or the song.

In some implementations, a media item creator may set and/or change distribution information 25 for a media item. For example, the media item creator of the music video may provide an alternative rights distribution than the rights distribution provided in rights interface 600 (e.g., determined based on derivative charge rules for the video and the song). The media item creator's alternative rights distribution may be provided to other rights-holders for confirmation, rejection, or counter-offer.

Media information component 110 may be configured to provide one or more media information defining one or more media item to a consumer device. Media information component 110 may provide one or more media information to a consumer device upon reception of a request for the particular media item(s). Media information component 110 may provide one or more media information to a consumer device upon confirmation that the corresponding consumer account includes sufficient value to “pay for” the consumption of the media item(s). Media information component 110 may provide one or more media information to a consumer device after making changes to the corresponding consumer account value, media account values, and/or distribution account values.

Use of system 10 and the components of system 10 may enable efficient management of account values based on consumption of media items. System 10 may provide for derivative consumption of media items having different charge rules and/or different distribution rules (e.g., different licenses for use/royalty payment). System 10 may provide for automatic distribution of media account values for different distribution accounts. System 10 may provide information that enables creators/consumers of media items to know when a particular consumption of media item(s) is not allowed under the charge rules and/or distribution rules, and may enable creators/consumers of media items to change the consumption of media item(s) to find a particular permissible consumption of media item(s).

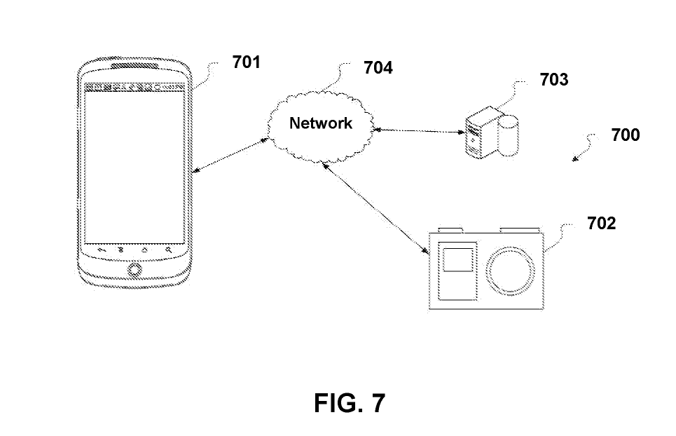

FIG. 7 illustrates exemplary system 700 including consumer devices 701, 702, one or more servers 703, and network 704. Server(s) 703 may be configured to communicate with consumer devices 701, 702 through network 704. Server(s) 703 may communicate with consumer devices 701, 702 according to a client/server architecture. Server(s) 703 may provide one or more processing functionalities disclosed herein for managing consumption of media items. Server(s) 703 may provide for cloud computing and/or cloud storage for managing consumption of media items. For example, server(s) 703 may provide one or more functionalities of consumption event component 102, consumption information component 104, account value component 106, charge information component 108, media information component 110, distribution component 112, storage media 12, and/or other components disclosed herein.

Users may use consumer devices 701, 702 to provide and/or consume media items. For example, a user may use consumer device 702 (e.g., camera) to upload one or more media items (e.g., image, video) to server(s) 703. The uploaded media items may be available to one or more users of system 700. A user may use consumer device 701 (e.g., handheld device) to consume one or more media items stored in server(s) 703. For example, a user may use consumer device 701 to consume a remixed song. The remixed song may include/use of 5 different songs. Based on the user's request for the remixed song, server(s) 703 may provide a stored version of the remixed song to consumer device 701; pull the 5 songs, and create and serve the remixed song; or pull and provide the 5 songs to consumer device 701 for remixing by consumer device 701. Based on the user's consumption of the remixed song, the media account values for the individual songs may be increased. For example, the royalty for consumption of the remixed song may be divided equally among the media account values—individual media account values may be increased by 20% of the royalty.

In some implementations, one or more media items may be suggested to users for consumption. For example, one or more media items may be provided in a list to a user based on the user's prior consumption of media item, prior independent and/or dependent uses of media items, media items in the user's library (e.g., individual songs/genre of songs in the user's library), media items in other users' library associated with the user (e.g., libraries of friends of the user linked at various portals), and/or other information. In some implementations, one or more media items may be suggested to users for consumption based on other media item(s) selected by the users for consumption. For example, a user may have selected a surfing video for consumption. Based on the surfing video, one or more particular songs/music may be suggested to the user for derivative consumption with the surfing video. In some implementations, one or more media items may be suggested to users for consumption using machine learning. In some implementations, server(s) 703 and/or consumer devices 701, 702 may provide a warning to a user when a given media item does not provide sufficient privilege(s) for the desired consumption (e.g., a particular type of derivative consumption) and/or requires additional royalties (e.g., $1) for consumption.

In some implementations, users may be required to login to a platform (e.g., via server(s) 703) to consume one or more media items. For example, a platform may include a trusted environment in which access to media items is restricted to members of the platform. To consume one or more media items, users may be prompted to provide information that authenticates the users as members (e.g., a username or handle, a number, an identifier, a login code, a password, a user ID).

Authenticated/validated users may be provided with access to the media items. If not a member, users may be prompted to join and register as members to access the media items. In some implementations, access to one or more media items may be restricted based on the membership level of the users. For example, a platform may include different levels of membership levels with different levels of access to media items. Different levels of access may define access to different media items (e.g., certain media items are available/not available to certain levels) and/or may define access to different consumption of media items (e.g., certain types of derivative consumptions are available/not available to certain levels).

In some implementations, access to media items may be provide though a zero trust environment. In a zero trust environment, distributed users may gain access to the media items based on verification of individual requests for access to the media items. In some implementations, the consumption of individual media items may be tracked via blockchain (transactional history) tracking. The amount of consumption of media items may be reviewed on a periodic basis. For example, the amount of consumption of media items may be reviewed at the end of each 24-hour (or other time period) cycles.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible computer readable storage medium may include read only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure, and performing certain actions.

Although processor 11 and storage media 12 are shown to be connected to interface 13 in FIG. 1, any communication medium may be used to facilitate interaction between any components of system 10. One or more components of system 10 may communicate with each other through hard-wired communication, wireless communication, or both. For example, one or more components of system 10 may communicate with each other through a network. For example, processor 11 may wirelessly communicate with storage media 12. By way of non-limiting example, wireless communication may include one or more of radio communication, Bluetooth communication, Wi-Fi communication, cellular communication, infrared communication, or other wireless communication. Other types of communications are contemplated by the present disclosure.

Although processor 11 is shown in FIG. 1 as a single entity, this is for illustrative purposes only. In some implementations, processor 11 may comprise a plurality of processing units. These processing units may be physically located within the same device, or processor 11 may represent processing functionality of a plurality of devices operating in coordination. Processor 11 may be configured to execute one or more components by software; hardware; firmware; some combination of software, hardware, and/or firmware; and/or other mechanisms for configuring processing capabilities on processor 11.

It should be appreciated that although computer components are illustrated in FIG. 1 as being co-located within a single processing unit, in implementations in which processor 11 comprises multiple processing units, one or more of computer program components may be located remotely from the other computer program components.

The description of the functionality provided by the different computer program components described herein is for illustrative purposes, and is not intended to be limiting, as any of computer program components may provide more or less functionality than is described. For example, one or more of computer program components 102, 104, 106, 108, 110, and/or 112 may be eliminated, and some or all of its functionality may be provided by other computer program components. As another example, processor 11 may be configured to execute one or more additional computer program components that may perform some or all of the functionality attributed to one or more of computer program components 102, 104, 106, 108, 110, and/or 112 described herein.

The electronic storage media of storage media 12 may be provided integrally (i.e., substantially non-removable) with one or more components of system 10 and/or removable storage that is connectable to one or more components of system 10 via, for example, a port (e.g., a USB port, a Firewire port, etc.) or a drive (e.g., a disk drive, etc.). Storage media 12 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. Storage media 12 may be a separate component within system 10, or storage media 12 may be provided integrally with one or more other components of system 10 (e.g., processor 11). Although storage media 12 is shown in FIG. 1 as a single entity, this is for illustrative purposes only. In some implementations, storage media 12 may comprise a plurality of storage units. These storage units may be physically located within the same device, or storage media 12 may represent storage functionality of a plurality of devices operating in coordination.

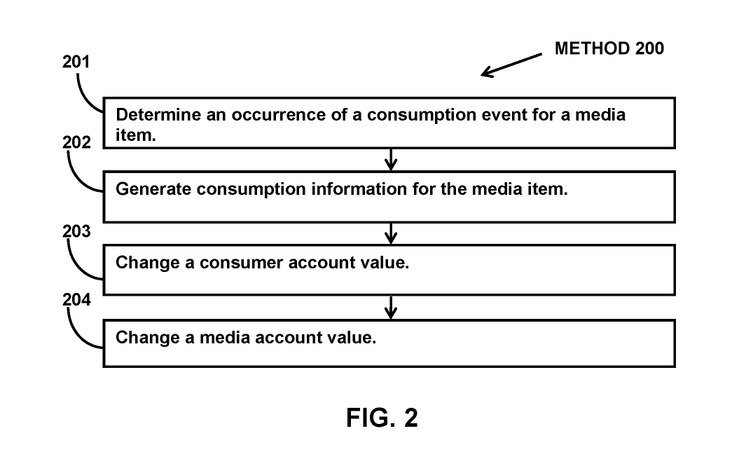

FIG. 2 illustrates method 200 for managing consumption of media items. The operations of method 200 presented below are intended to be illustrative. In some implementations, method 200 may be accomplished with one or more additional operations not described, and/or without one or more of the operations discussed. In some implementations, two or more of the operations may occur substantially simultaneously.

In some implementations, method 200 may be implemented in one or more processing devices (e.g., a digital processor, an analog processor, a digital circuit designed to process information, a central processing unit, a graphics processing unit, a microcontroller, an analog circuit designed to process information, a state machine, and/or other mechanisms for electronically processing information). The one or more processing devices may include one or more devices executing some or all of the operation of method 200 in response to instructions stored electronically on one or more electronic storage mediums. The one or more processing devices may include one or more devices configured through hardware, firmware, and/or software to be specifically designed for execution of one or more of the operation of method 200.

Referring to FIG. 2 and method 200, at operation 201, an occurrence of a consumption event for a media item may be determined. In some implementation, operation 201 may be performed by a processor component the same as or similar to consumption event component 102 (Shown in FIG. 1 and described herein).

At operation 202, consumption information for the media item may be generated. In some implementations, operation 202 may be performed by a processor component the same as or similar to consumption information component 104 (Shown in FIG. 1 and described herein).

At operation 203, a consumer account value may be changed. In some implementations, operation 203 may be performed by a processor component the same as or similar to account value component 106 (Shown in FIG. 1 and described herein).

At operation 204, a media account value may be changed. The media account value may be changed based on the consumption information. In some implementations, operation 204 may be performed by a processor component the same as or similar to account value component 106 (Shown in FIG. 1 and described herein).

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

What is claimed is:

1. A system for managing consumption of media items, the system comprising:
physical storage media storing a database, the database including:
media account information for media accounts corresponding to individual media items, the media account information for individual media accounts including a media account value, the media accounts including a first media account corresponding to a first media item, the media account information for the first media account including a first media account value;
consumer account information for consumer accounts corresponding to individual consumers, the consumer account information for individual consumer accounts including a consumer account value, the consumer accounts including a first consumer account corresponding to a first consumer, the consumer account information for the first consumer account including a first consumer account value; and
charge information for the individual media accounts, the charge information defining independent charge rules for independent consumption of the individual media items and derivative charge rules for derivative consumption of the individual media items, the charge information including first charge information for the first media account, the first charge information defining a first independent charge rule and a first derivative charge rule for the first media item; and
one or more physical processors configured by machine-readable instructions to:
determine an occurrence of a consumption event for one or more of the media items; and
responsive to determination of the occurrence of the consumption event for the first media item:
generate consumption information for the first media item, the consumption information identifying (i) the first consumer account based on the first consumer's consumption of the first media item, (ii) a date and/or a time of the first consumer's consumption of the first media item, and (iii) a type of the first consumer's consumption of the first media item;
change the first consumer account value; and
change the first media account value based on the first charge information and the consumption information, wherein:
the first media account value is changed using the first independent charge rule based on the consumption information indicating an independent consumption of the first media item; and
the first media account value is changed using the first derivative charge rule based on the consumption information indicating a derivative consumption of the first media item.

2. The system of claim 1, wherein the one or more physical processors are further configured by machine-readable instructions to set or change the charge information.

3. The system of claim 1, wherein the one or more physical processors are further configured by machine-readable instructions to store first media information defining the first media item in one or more storage media.

4. The system of claim 3, wherein the one or more physical processors are further configured to provide the first media information defining the first media item to a consumer device.

5. The system of claim 1, wherein the consumption information further identifies a consumer device used for the first consumer's consumption of the first media item.

6. The system of claim 1, wherein changing the first consumer account value includes decreasing the first consumer account value by a charge value.

7. The system of claim 6, wherein changing the first media account value includes increasing the first media account value by at least a portion of the charge value.

8. The system of claim 7, wherein:
the database further includes:
distribution account information for a set of distribution accounts associated with the first media account, the set of distribution accounts including one or more distribution accounts, the distribution account information for individual distribution accounts including a distribution account value; and
distribution information associated with the first media account, the distribution information defining a distribution rule for distributing at least a portion of the increase in the first media account value among the set of distribution accounts; and
the one or more physical processors are further configured by machine-readable instruction to distribute at least the portion of the increase in the first media account value among the set of distribution accounts using the distribution rule.

9. The system of claim 8, wherein the set of distribution accounts includes a rights-holder account.

10. The system of claim 8, wherein the set of distribution accounts includes a second media account corresponding to a second media item.

11. A method for managing consumption of media items, the method comprising:
changing information stored in a database based on consumption of media items, the database stored in physical storage media, the database including:
media account information for media accounts corresponding to individual media items, the media account information for individual media accounts including a media account value, the media accounts including a first media account corresponding to a first media item, the media account information for the first media account including a first media account value;
consumer account information for consumer accounts corresponding to individual consumers, the consumer account information for individual consumer accounts including a consumer account value, the consumer accounts including a first consumer account corresponding to a first consumer, the consumer account information for the first consumer account including a first consumer account value; and
charge information for the individual media accounts, the charge information defining independent charge rules for independent consumption of the individual media items and derivative charge rules for derivative consumption of the individual media items, the charge information including first charge information for the first media account, the first charge information defining a first independent charge rule and a first derivative charge rule for the first media item;
wherein changing the information stored in the database includes:
determining an occurrence of a consumption event for one or more of the media items; and
responsive to determination of the occurrence of the consumption event for the first media item:
generating consumption information for the first media item, the consumption information identifying (i) the first consumer account based on the first consumer's consumption of the first media item, (ii) a date and/or a time of the first consumer's consumption of the first media item, and (iii) a type of the first consumer's consumption of the first media item;
changing the first consumer account value; and
changing the first media account value based on the first charge information and the consumption information, wherein:
the first media account value is changed using the first independent charge rule based on the consumption information indicating an independent consumption of the first media item; and
the first media account value is changed using the first derivative charge rule based on the consumption information indicating a derivative consumption of the first media item.

12. The method of claim 11, further comprising setting or changing the charge information.

13. The method of claim 11, further comprising storing first media information defining the first media item in one or more storage media.

14. The method of claim 13, further comprising providing the first media information defining the first media item to a consumer device.

15. The method of claim 11, wherein the consumption information further identifies a consumer device used for the first consumer's consumption of the first media item.

16. The method of claim 11, wherein changing the first consumer account value includes decreasing the first consumer account value by a charge value.

17. The method of claim 16, wherein changing the first media account value includes increasing the first media account value by at least a portion of the charge value.

18. The method of claim 17, wherein the database further includes:
distribution account information for a set of distribution accounts associated with the first media account, the set of distribution accounts including one or more distribution accounts, the distribution account information for individual distribution accounts including a distribution account value; and
distribution information associated with the first media account, the distribution information defining a distribution rule for distributing at least a portion of the increase in the first media account value among the set of distribution accounts; and
further comprising distributing at least the portion of the increase in the first media account value among the set of distribution accounts using the distribution rule.

19. The method of claim 18, wherein the set of distribution accounts includes a rights-holder account.

20. The method of claim 18, wherein the set of distribution accounts includes a second media account corresponding to a second media item.
